(19) United States
(12) Patent Application Publication
(10) Pub. No.: US 2017/0345333 A1
(43) Pub. Date: Nov. 30, 2017

(54) CONDITIONING DEVICE

(71) Applicant: Robert Nelson Brummell, Mechanicsville, VA (US)

(72) Inventor: Robert Nelson Brummell, Mechanicsville, VA (US)

(21) Appl. No.: 15/168,530

(22) Filed: May 31, 2016

(51) Int. Cl. G09B 19/00; B32B 7/12; B32B 7/08; G09B 5/06; A63B 21/00

(52) U.S. Cl. CPC G09B 19/003; G09B 5/06; A63B 21/00047; B32B 7/08; B32B 7/12

(57) ABSTRACT

A multi-layered composite for performing cardiovascular/pulmonary training comprising a first core layer, the upper surface of which is adapted for frictional contact with a body part of a user of the composite and a lower surface affixed to a second layer adapted for frictional contact with a floor of a venue occupied by the user, and a kit and method of performing cardiovascular/pulmonary conditioning.

### BACKGROUND OF THE INVENTION

Currently available systems for cardiovascular conditioning require expensive machines and/or weights. Devices such as bar bells and dumb bells used in strength exercise programs result, to a small degree, only in insignificant increases in blood circulation. They are at best, therefore, minimally effective insofar as conditioning the circulatory and respiratory systems. Numerous types of apparatuses are also available for performing cardiovascular exercises at home or in places such as fitness clubs and wellness centers, such as the classic exercise bikes that enable users to simulate riding a bicycle without any need to go anywhere or have much space available, or the recumbent bikes (also called reclining bikes) that are used-like the classic exercise bike-to simulate a cycling action but in a reclining position in order to avoid strain on the back muscles and spine. Other types of equipment are used instead to exercise the upper parts of the body in order to keep the arms and shoulders active too while performing cardiovascular exercises. Examples of such equipment are the arm pedal exercisers that involve performing a pedaling action with the upper limbs to exercise the shoulders and arms.

These types of equipment have several technical drawbacks, however, relating to their dimensions and to the limited uses to which they can be put, which is strictly related to the type of equipment used. This strongly restricts their use at home or wherever space is limited, and prevents users from varying the exercise and the type of training they can choose. In addition, the dimensions of the equipment may make it impossible to install several different machines at home, and this again limits the opportunities for users of such machines to choose between different types of exercise.

Finally, the use of weights and machines can be detrimental to the user's joints.

The present invention relates to a system and method for cardio conditioning without utilizing machines or weights.

### SUMMARY OF THE INVENTION

An embodiment of the invention relates to a multi-layered composite for performing cardiovascular/pulmonary training comprising a core layer, the upper surface of which is adapted for frictional contact with a body part of a user of the composite and a lower surface affixed to a layer adapted for frictional contact with a floor of a venue occupied by the user.

Another embodiment of the invention relates to a method for performing cardiovascular/pulmonary training wherein a user positions the above described composite such that the lower surface thereof frictionally contacts a floor, places a body part in frictional contact with the upper surface of the composite such that the composite bears a significant portion of the weight of the user, and drives the composite over the floor utilizing at least one other body part to overcome the resistance friction provided between the lower surface of the composite and the floor.

These and other features, aspects and advantages of the present invention will become better understood with reference to the following drawings, description and claims.

### BRIEF DESCRIPTION OF THE DRAWINGS

FIG. 1 is a perspective view of the invention shown in use.

FIG. 2 is a perspective view of the invention.

FIG. 3 is an exploded view of the invention.

FIG. 4 is a section view of the invention taken from 4-4 in FIG. 1.

FIG. 5 is a perspective view illustrating an alternate use.

FIG. 6 is a perspective view illustrating an alternate use.

FIG. 7 is a perspective view illustrating an alternate use.

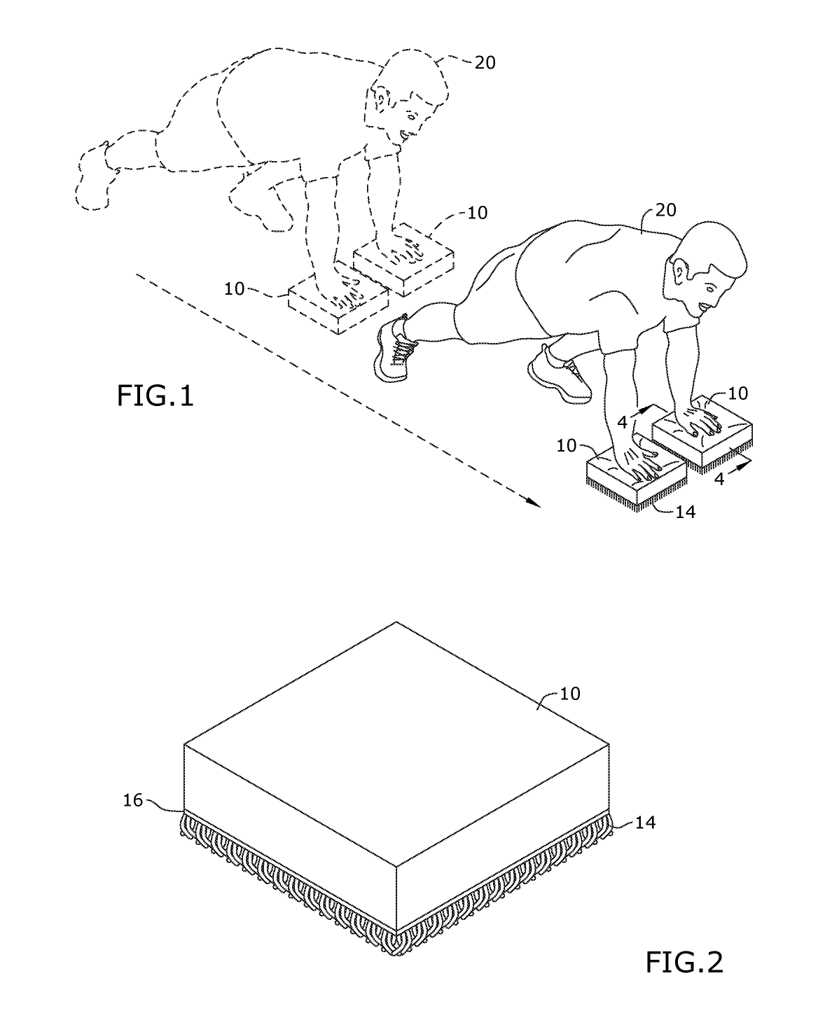

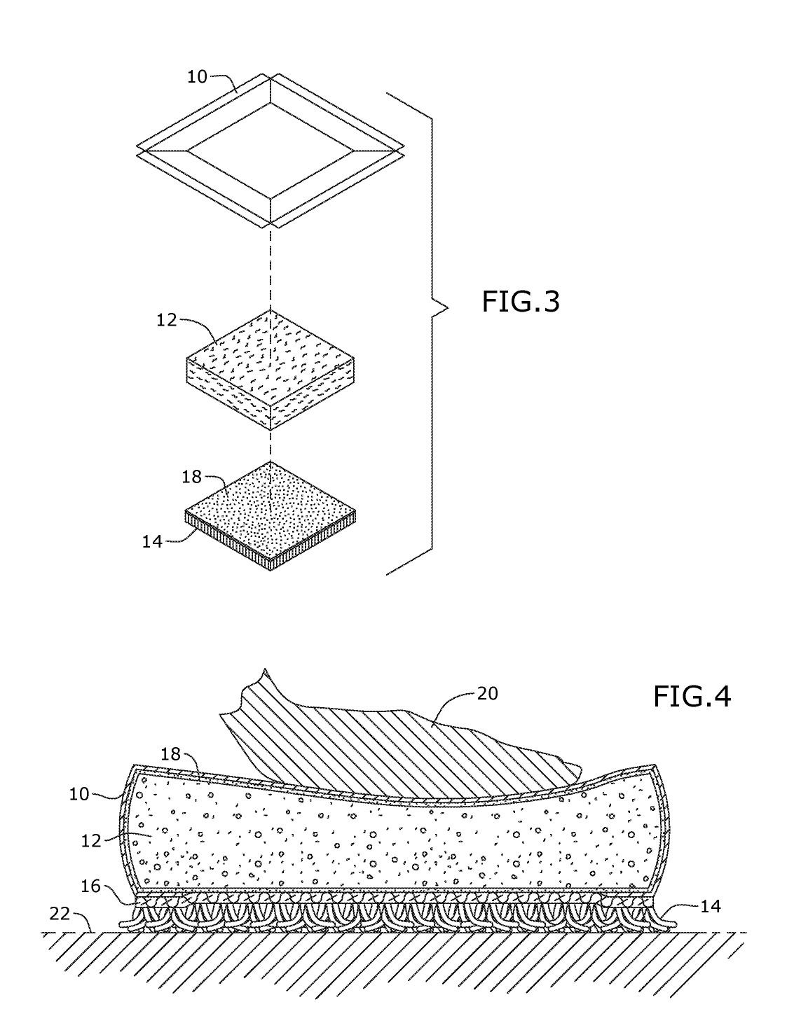

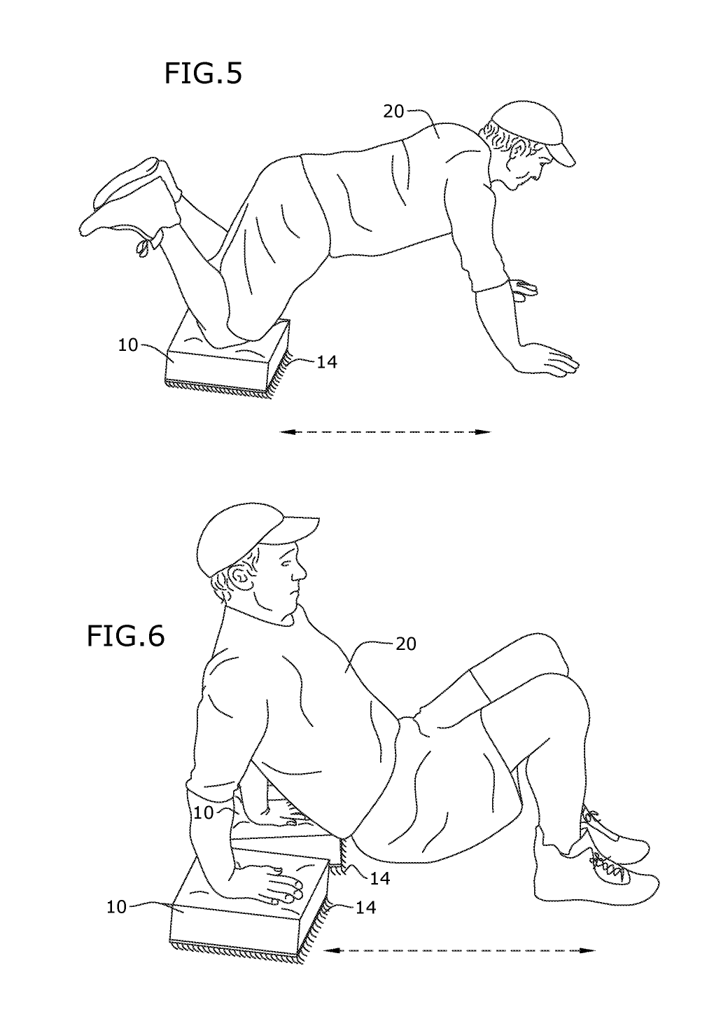

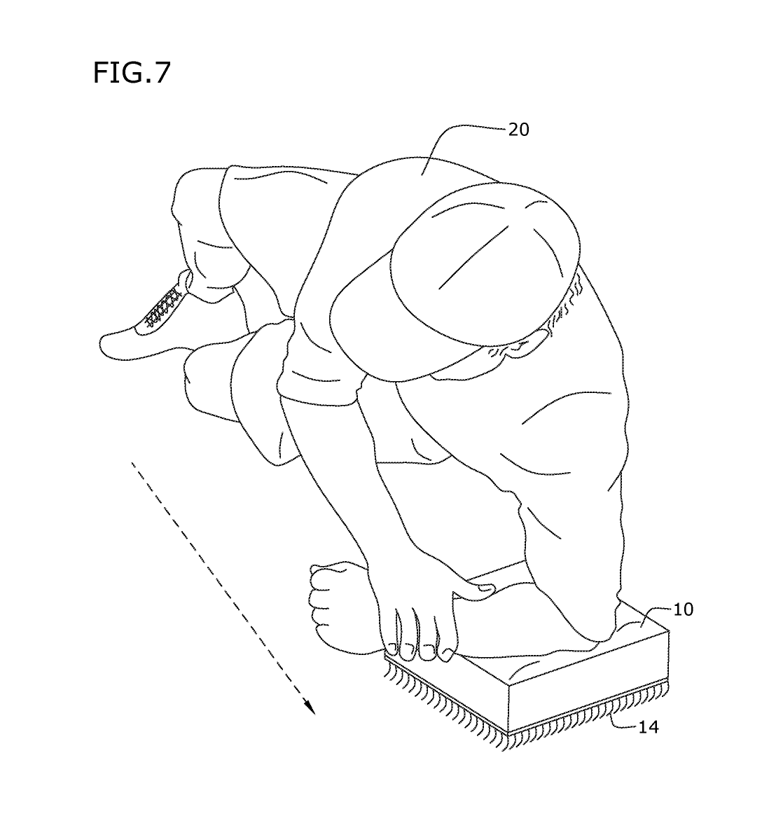

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a device for performing cardiovascular/pulmonary training which utilizes the user's own weight to overcome inertial resistance to elevate heart rate and breathing, thereby avoiding the disadvantages associated with the use of conventional weights and machines.

The crux of the invention is predicated on the discovery of a system whereby a user can use his/her own weight to provide the resistance necessary to achieve cardiovascular/pulmonary conditioning while performing an exercise that does not require weights or machinery and does not deleteriously affect the user's joints.

Referring to the drawings, a preferred embodiment of the invention comprises a multilayered composite comprising base layer 14 to which is affixed a core layer 12 which is adapted for positioning of a body part of the user. In the depicted preferred embodiment, the core layer 12 is affixed to the base layer by adhesive layer/coating 18; however, it will be understood by those skilled in the art that the layers may be joined by any suitable means, including, but not limited to stitching, stapling and the like.

Optionally, a protective cover 10 may be overlaid on the upper surface of the core layer 12. The protective cover is constructed of any material suitable for the purpose, including, but not limited to neoprene, leather, vinyl, LYCRA® (Spandex), alcantara and the like. Preferably, the cover layer 10 is positioned over the core layer and held in place by adhesive layer 18.

Depending upon the material employed to construct the base layer, a backing layer 16 for providing requisite stiffness and strength to the base layer may be positioned over the surface thereof which is affixed to the core layer 12/cover layer 10.

In usage, the device is placed in a desired location with the base layer 14 contacting the floor 22. The user positions a body part 20 on the exposed surface of the core layer 12 such that a significant portion of the weight of the user is supported by the device.

Base layer 14 comprises a material which is adapted for slidable contact with the floor of a venue occupied by the user of the device. The degree of slidability is dependent on the coefficient of friction between the material employed to construct element 14 and the floor upon which it rests when in use, as well as the amount of weight thereon upon the user positioning a body part on core layer 12. The base layer 14 may be formed of any material suitable for the purpose, including, but not limited to, carpet, cotton yarn sewn to a synthetic backing, terrycloth, nylon, microfiber and the like.

The core layer 12 is preferably constructed of a material upon which a user may comfortably position a body part and support a significant portion of his/her weight. The core layer 12 may be formed of any material suitable for the purpose, including, but not limited to, polyurethane foam, latex rubber, cotton, kapok fiber stuffing, soft hemp fiber stuffing and the like.

Those skilled in the art, having knowledge of the disclosure herein will be aware of the many exercises in which the device of the invention can be utilized to achieve cardiovascular/pulmonary conditioning.

For example, two of the devices may be placed on the floor approximately shoulder width apart. The user would position a hand on each device with the legs extended back such that the devices support most of the user's weight; i.e., in a push-up position.

Those skilled in the art will be aware that there are numerous and varied ways to utilize the device of the invention. Although the preferred shape of the device is rectangular, it may assume any shape/size suitable for the exercise to which it will be put.

Employing two devices, the user, who is face-down to the floor, would place a hand on each, with their legs stretched out to the rear. While elevating their upper body, the user would drive the slidable device across the floor with their legs.

The user's own body weight, coupled with the coefficient of friction between the device and the floor, provides all of the resistance required to enable cardiovascular/pulmonary conditioning.

Alternatively, with their back to the floor, the user would place their hands on the two devices behind their back and leg-drive the devices across the floor.

In still another embodiment, the user places their knees on the two devices and employs arm-drive to push them across the floor in any desired direction.

Employing one device, the user with their side facing down, places an elbow thereon and leg-drives it across the floor by alternately high-stepping over the lower. The user could then switch elbows and repeat the method.

The system of the invention enables its users to work virtually every muscle in the body and achieve a very intense cardio/pulmonary conditioning workout in a short period of time with no machines or weights.

It should be understood, of course, that the foregoing relates to exemplary embodiments of the invention and that modifications may be made without departing from the spirit and scope of the invention as set forth in the following claims.

What is claimed is:

1. A multi-layered composite for performing cardiovascular/pulmonary training comprising a first core layer, the upper surface of which is adapted for frictional contact with a body part of a user of the composite and a lower surface affixed to a second layer adapted for frictional contact with a floor of a venue occupied by the user.

2. The composite of claim 1, wherein the core layer is affixed to the second layer by an adhesive, stitching or stapling.

3. The composite of claim 1, wherein additionally comprising a protective cover overlaid on the upper surface of the core layer.

4. The composite of claim 3, wherein the protective cover is constructed of neoprene.

5. The composite of claim 1, wherein the cover layer is positioned over the core layer and held in place by adhesive.

6. The composite of claim 1, wherein the second layer is provided with a backing layer adapted to provide the desired stiffness and strength thereto.

7. A method for performing cardiovascular/pulmonary training wherein a user places a body part on the upper surface of the composite of claim 1 and while supporting a significant portion of the user's weight, drives the composite across a substrate supporting the composite utilizing at least one other body part.

8. A kit for performing cardiovascular/pulmonary training comprising at least one composite according to claim 1 and a suitably-sized package for containing the at least one composite in kit form until use.

9. The kit of claim 8 additionally comprising a set of instructions associated with the kit and being in the form of written instructions and/or audio/visual instructions for the person to perform cardiovascular/pulmonary conditioning exercises
